(19) United States
(12) Patent Application Publication
(10) Pub. No.: US 2014/0211314 A1
(43) Pub. Date: Jul. 31, 2014

(54) EFFICIENCY OF A DEEP GRATING

(71) Applicant: Optoplex Corporation, Fremont, CA (US)

(72) Inventor: Yung-Chieh Hsieh, San Jose, CA (US)

(73) Assignee: Optoplex Corporation, Fremont, CA (US)

(21) Appl. No.: 14/242,712

(22) Filed: Apr. 1, 2014

Related U.S. Application Data
(63) Continuation-in-part of application No. 13/150,404, filed on Jun. 1, 2011.
Application No. 13/150,404 is a continuation-in-part of application No. 11/360,959, filed on Feb. 22, 2006, now abandoned.
Application No. 11/360,959 is a continuation-in-part of application No. 12/928,189, filed on Dec. 6, 2010, now Pat. No. 8,705,176.
Application No. 12/928,189 is a division of application No. 12/174,628, filed on Jul. 16, 2008, now Pat. No. 7,864,430.
Application No. 12/174,628 is a continuation-in-part of application No. 11/485,653, filed on Jul. 11, 2006, now Pat. No. 7,522,343.
Application No. 11/485,653 is a continuation-in-part of application No. 11/360,959, filed on Feb. 22, 2006, now abandoned.
(60) Provisional application No. 61/807,246, filed on Apr. 1, 2013.
(60) Provisional application No. 61/350,109, filed on Jun. 1, 2010.
(60) Provisional application No. 60/950,142, filed on Jul. 17, 2007.

(51) Int. Cl. G02B 5/18

(52) U.S. Cl. CPC G02B 5/1809
USPC 359/576; 359/569

(57) ABSTRACT

Several techniques are provided to reduce the spurious reflection generated at the exit surface of a transmission grating. In one embodiment the exit surface of the grating is not parallel with the entrance surface. In another embodiment, the first and second surfaces of the grating are parallel and a second substrate is attached to the second surface of the grating. The second substrate has an entrance surface and an exit surface having at least a wedge angle relative to the entrance surface. In another embodiment, a second substrate is fixedly connected to the second surface of a parallel plate grating, where the second substrate has an entrance surface and an exit surface. The exit surface is curved such that it will be about normal to a beam transmitted over a range of angels of incidence onto the grating region.

### CROSS-REFERENCE TO RELATED APPLICATIONS

This application claims the benefit of U.S. Provisional Patent Application No. 61/807,246 titled “Improvement of the Efficiency of a Deep Grating,” filed Apr. 1, 2013, incorporated herein by reference. This is a continuation-in-part of U.S. patent application Ser. No. 13/150,404, filed Jun. 1, 2011, and incorporated herein by reference. U.S. patent application Ser. No. 113/150,404 is a continuation-in-part of U.S. patent application Ser. No. 11/360,959, filed Feb. 22, 2006, and incorporated herein by reference. U.S. patent application Ser. No. 13/150,404 claims the benefit of U.S. Provisional Patent Application No. 61/350,109, filed Jun. 1, 2010, incorporated herein by reference. This is a continuation in part of U.S. patent application Ser. No. 12/928,189 filed Dec. 6, 2010, and incorporated herein by reference. U.S. patent application Ser. No. 12/928,189 is a divisional of Ser. No. 12/174,628, filed Jul. 16, 2008, incorporated herein by reference, which claims priority to 60/950,142, filed Jul. 17, 2007, incorporated herein by reference. U.S. patent application Ser. No. 12/928,189 is a CIP of Ser. No. 11/485,653, incorporated herein by reference filed Jul. 11, 2006 which is a CIP of Ser. No. 11/360,959, incorporated herein by reference tiled Feb. 22, 2006.

### BACKGROUND OF THE INVENTION

1. Field of the Invention

The present invention relates to transmission gratings, and more specifically, it relates to techniques for improving the efficiency of such gratings.

2. Description of Related Art

A grating can be fabricated on one surface of a plane parallel substrate using a lithographic process. The period of groove is less than the wavelength. In the case where

λ/sinα=2p, (1)

where p is the groove period and α is the angle of the incidence, then two propagation modes of the grating are excited Almost all input energy transmits in these two modes. By selecting the fill factor and the groove depth one can design a grating with efficiency near 100% in a single mode, 31 1^{st} order (Clausnitzer, 2005). For given α and p, the diffraction angle, β, can be derived from the grating equation,

sinα/λ+sinβ/λ=1/p, (2)

and the dispersion of the grating is then

dβ/dλ=1/p/cosβ. (3)

Therefore, as shown in Table 1, the denser the groove pattern, the better the resolution.

TABLE 1

| Grating | | | |
|---|---|---|---|
| [line | Wavelength | Angle of | Resolution |
| pair/mm] | [nm] | Incidence [deg] | [deg/nm] |
| 966 | 1545 | 48.3 | 0.083 |
| 1200 | 1545 | 68.0 | 0.183 |

From Eq. (1), in order to have a high efficiency, a grating with a denser groove pattern needs a greater incidence angle, α. The diffracted beam leaves the grating region, propagates in the substrate region in an angle γ, and finally exits the substrate in angle, β, which is determined by Snell's law,

n×sin γ=sin β (4)

FIG. 1 shows the angle of the transmitted beam per wavelength for a grating with 1200 line pairs per mm, wherein the angle of incidence is 68 degrees. The upper plot shows the angle of the transmitted beam in air and the lower plot shows the angle of the transmitted beam in the substrate. The angle of the transmitted beam in air varies from about 64 degrees to about 72 degrees as the wavelength increases. It well known that it is difficult to make an antireflective (AR) coating for a large incident angle. In addition, at a large incidence angle, the coating is sensitive to the polarization of the beam. Without a proper coating on the exit surface of a transmission grating, the spurious reflection by the grating exit surface will interfere with the transmitted beam, and significantly affect the efficiency. Moreover, the degree of this effect is a function of the wavelength. In other words, the efficiency varies periodically with the wavelength due to the spurious reflection. Therefore, there is a need to reduce the spurious reflection from the exit surface of the grating.

### SUMMARY OF THE INVENTION

For numerous applications, it is desirable to reduce the spurious reflection generated at the exit surface of a grating. The present invention provides several solutions to this problem. In a general embodiment, a transmission grating is formed of a substrate having a first surface and a second surface and a grating region is fixedly connected to the first surface and includes a groove period that is less than the wavelength of a desired beam incident on the grating region, where the first surface is not parallel with the second surface. The embodiment can also include an antireflection coating on the second surface. This surface may be curved.

In another general embodiment, a transmission grating is formed of a substrate that includes a first surface and a second surface and a grating region fixedly connected to the first surface and includes a groove period that is less than the wavelength of a desired beam incident on the grating region, where the first surface is about parallel with the second surface. In this embodiment, a second substrate is fixedly connected to the second surface, where the second substrate has an entrance surface and an exit surface having at least a wedge angle relative to the entrance surface. Thus, the second substrate can be a wedge in some embodiments. In another embodiment, the second substrate can be a prism. The exit surface can include an antireflection coating. The second substrate can be attached to said first substrate by an optical bond between the second surface and the entrance surface. Alternate attachment means can be used. For example, the second substrate can be attached to the first substrate by using adhesive behveen the second surface and the entrance surface.

In still another general embodiment, a transmission grating is formed of a substrate that includes a first surface and a second surface and a grating region fixedly connected to the first surface and includes a groove period that is less than the wavelength of a desired beam incident on the grating region, where the first surface is about parallel with the second surface. In this embodiment, a second substrate is fixedly connected to the second surface, where the second substrate has an entrance surface and an exit surface that is curved. The curvature of the exit surface is configured to be about normal to a beam transmitted over a range of angels of incidence onto the grating region.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows the angle of the transmitted beam per wavelength for a grating with 1200 line pairs per mm.

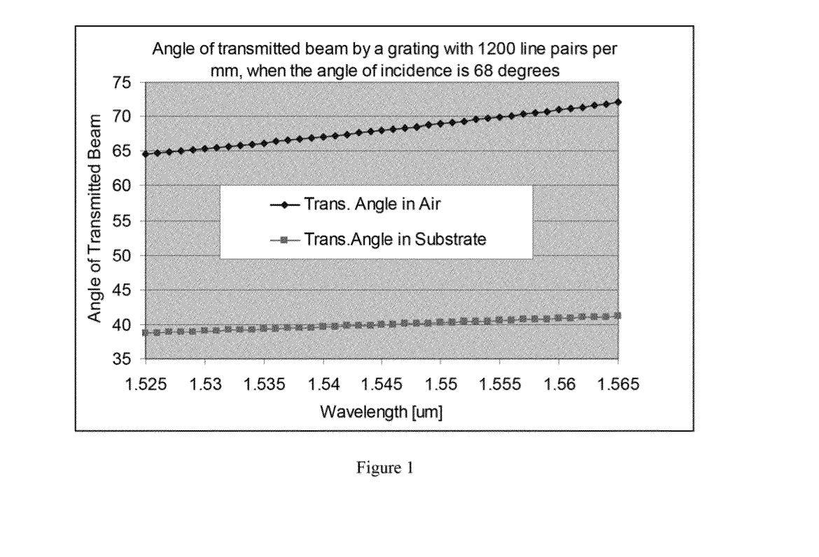

FIG. 2 shows a deep grating on a plane parallel substrate.

FIG. 3 shows a right-angle prism attached to the exit surface of the substrate of FIG. 2.

FIG. 4 shows a curved substrate attached to the exit surface of the substrate of FIG. 2.

### DETAILED DESCRIPTION OF HE INVENTION

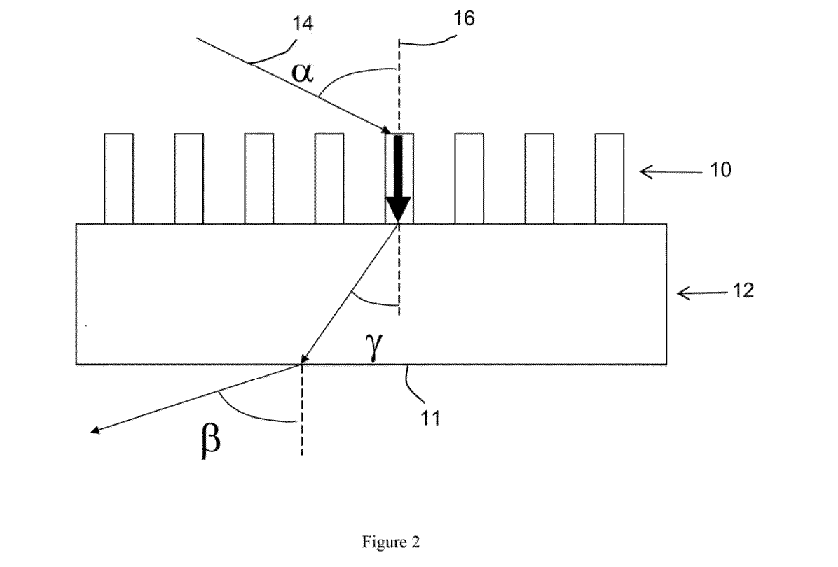

FIG. 2 shows a deep grating on a plane parallel substrate. The substrates generally have parallel major sides because a large number of gratings are made on a single large wafer. The upper part is the groove region 10, and the lower part is the substrate 12. The incidence beam 14 is at an angle α with respect to the normal 16 of the groove region 10 and substrate 12. The diffracted beam leaves the grating region, propagates in the substrate 10 at an angle γ and exits substrate 10 through surface 11. The exiting beam is oriented at an angle β with respect to the normal. For a large incidence angle in conventional gratings, there is a spurious reflection caused by the exit surface of the substrate.

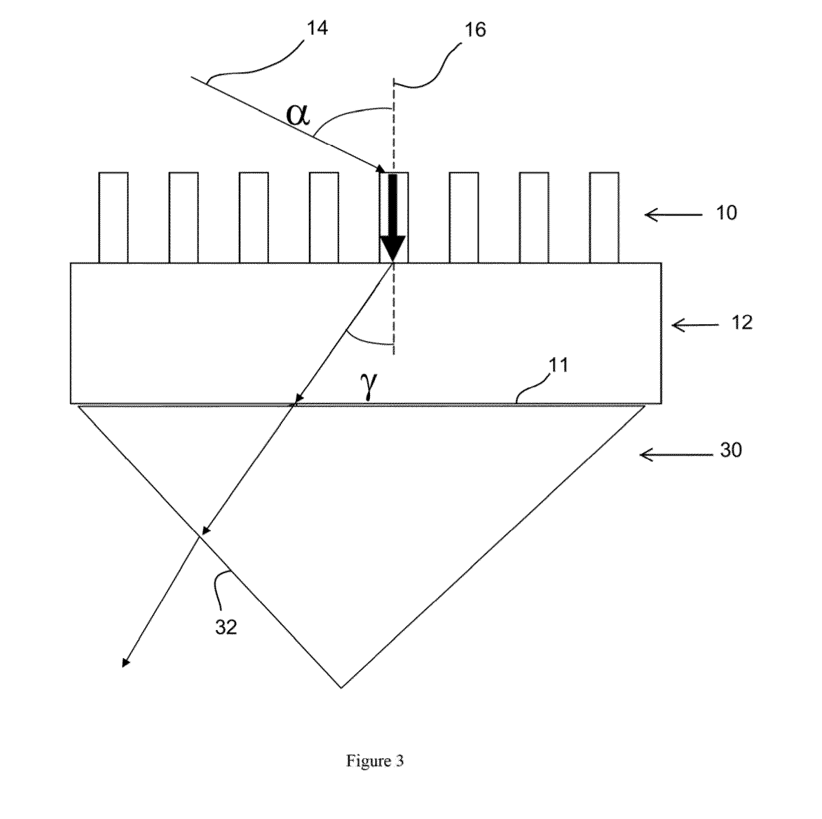

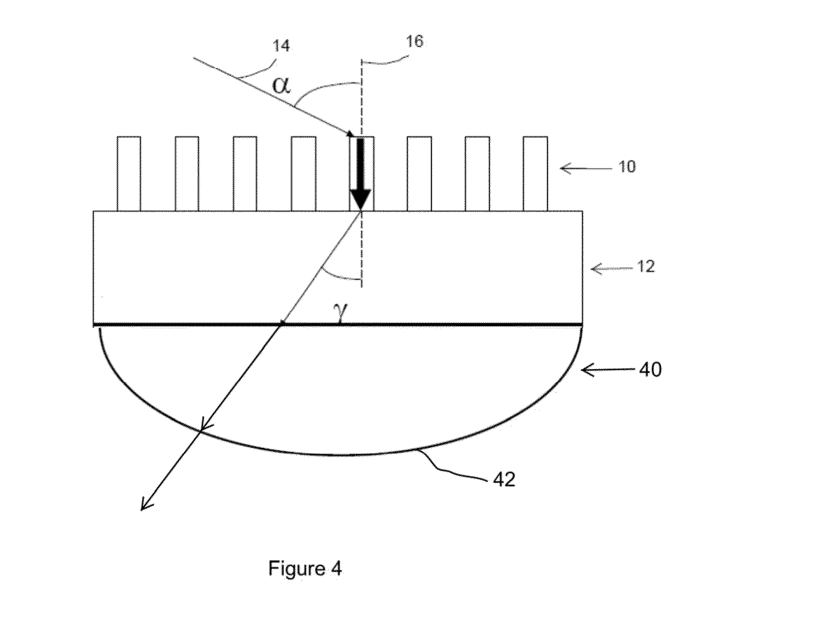

FIG. 3 shows a right-angle prism 30 attached to the exit surface 11 of the substrate 10 of FIG. 2. As a result, any spurious reflections caused by exit surface 11 are almost completely eliminated. The exit surface 32 of prism 30 can he arranged such that it is about normal to the transmitted beam in the prism. The exit surface of the prism can have an AR coating. Adhesion by optical contact may be used to attach the exit surface 11 of the substrate 10 to the entrance surface 34 of the prism 30. Alternately, the prism may be attached to the grating by other means such as the use of an adhesive. Non-adhesive means can also be used to attach the prism to the substrate. Based on the teachings herein, other geometries besides a right prism to reduce spurious reflections will be apparent to those skilled in the art. FIG. 4 shows a substrate 40 attached to surface 11. Substrate 40 has a curved exit surface 42. The curvature of this surface can he configured to be about normal to a beam transmitted over a range of angels of incidence onto the grating region. An antireflection coating can be applied to exit surfaces 32 of FIG. 3 and exit surface 42 of FIG. 4. It should be noted that theoretically, a grating formed on a substrate having non parallel planes of sufficient angles with respect to each other could be used to reduce the spurious reflections; however, as noted above, it is very difficult to manufacture gratings in bulk having such surfaces.

Thus, the present invention provides several embodiments that reduce the spurious reflection generated at the exit surface of a grating. In one embodiment, a transmission grating is formed of a substrate having a first surface and a second surface and a grating region is fixedly connected to the first surface and includes a groove period that is less than the wavelength of a desired beam incident on the grating region, where the first surface is not parallel with the second surface. The embodiment can also include an antireflection coating on the second surface. This surface may be curved. In another embodiment, a transmission grating is formed of a substrate that includes a first surface and a second surface and a grating region fixedly connected to the first surface and includes a groove period that is less than the wavelength of a desired beam incident on the grating region, where the first surface is about parallel with the second surface. In this embodiment, a second substrate is fixedly connected to the second surface, where the second substrate has an entrance surface and an exit surface having at least a wedge angle relative to the entrance surface. Thus, the second substrate can be a wedge in some embodiments. In another embodiment, the second substrate can be a prism. The exit surface can include an antireflection coating. The second substrate can be attached to said first substrate by an optical bond between the second surface and the entrance surface. Alternate attachment means can be used. For example, the second substrate can be attached to the first substrate by using adhesive between the second surface and the entrance surface. In still another general embodiment, a transmission grating is formed of a substrate that includes it first surface and a second surface and a grating region fixedly connected to the first surface and includes a groove period that is less than the wavelength of a desired beam incident on the grating region, where the first surface is about parallel with the second surface. In this embodiment, a second substrate is fixedly connected to the second surface, where the second substrate has an entrance surface and an exit surface that is curved. The curvature of the exit surface is configured to be about normal to a beam transmitted over a range of angels of incidence onto the grating region.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A transmission grating, comprising:
a substrate comprising a first surface and a second surface; and
a grating region fixedly connected to said first surface and comprising a groove period that is less than the wavelength of a desired beam incident on said grating region, wherein said first surface is not parallel with said second surface.

2. The grating of claim 1, wherein said second surface comprises an antireflection coating.

3. The grating of claim 1, wherein said second surface is angled relative to said entrance surface

4. The grating of claim 1, wherein said second surface is curved.

5. A transmission grating comprising:
a substrate comprising a first surface and a second surface;
a grating region fixedly connected to said first surface and comprising a groove period that is less than the wavelength of a desired beam incident on said grating region, wherein said first surface is about parallel with said second surface; and
a second substrate comprising an entrance surface and an exit surface, wherein said entrance surface is fixedly connected to said second surface, wherein said exit surface is angled relative to said entrance surface.

6. The grating of claim 5, wherein said second substrate comprises a wedge.

7. The grating of claim 5, wherein said second substrate comprises a prism.

8. The grating of claim 7, wherein said prism is a right prism.

9. The grating of claim 5, wherein said exit surface comprises an antireflection coating.

10. The grating of claim 5, wherein said second substrate is attached to said first substrate by an optical bond between said second surface and said entrance surface.

11. The grating of claim 5, wherein said second substrate is attached to said first substrate by using adhesive between said second surface and said entrance surface.

12. A transmission grating, comprising:
a substrate comprising a first surface and a second surface;
a grating region fixedly connected to said first surface and comprising a groove period that is less than the wavelength of a desired beam incident on said grating region, wherein said first surface is about parallel with said second surface; and
a second substrate comprising an entrance surface and an exit surface, wherein said entrance surface is fixedly connected to said second surface, wherein said exit surface is curved.

13. The grating of claim 12, wherein the curvature of said exit surface is configured to be about normal to a beam transmitted over a range of angels of incidence onto said grating region.
